(19) United States
(12) Patent Application Publication
(10) Pub. No.: US 2004/0054017 A1
(43) Pub. Date: Mar. 18, 2004

(54) Fractional regeneration of a weakly acidic ion exchanger loaded with bivalent metallic ions

(76) Inventors: Jan-Willem Brouwer, Willich (DE); Klaus Lepa, Troisdorf (DE); Jens Kroemer, Duesseldorf (DE); Patrick Droniou, Colombes (FR); Peter Kuhm, Hilden (DE); Dieter Mauer, Leverkusen (DE)

Correspondence Address: HENKEL CORPORATION, THE TRIAD, SUITE 200, 2200 RENAISSANCE BLVD., GULPH MILLS, PA, 19406, US

(21) Appl. No.: 10/416,121

(22) PCT Filed: Nov. 9, 2001
(86) PCT No.: PCT/EP01/12972

(30) Foreign Application Priority Data
Nov. 15, 2000 (DE) 100 56 628.6

(51) Int. Cl. C08J 5/20

(52) U.S. Cl. 521/26

(57) ABSTRACT

Process for the fractionated regeneration of a weakly acid ion exchanger charged with divalent metal ions selected from nickel, zinc and manganese ions, obtaining a phosphoric-acid valuable product solution which contains these metal ions, wherein at least two portions of aqueous phosphoric acid are added to the ion exchanger one after the other, wherein each successive portion of aqueous phosphoric acid shows a lower phosphoric acid concentration than the previous one, wherein after adding the first portion of aqueous phosphoric acid to the ion exchanger, a concentrate fraction in the form of a phosphoric-acid valuable product solution containing metal ions is flushed out which contains at least 0.5 wt. % metal ions and of which the volume is no greater than twice the volume of the first portion of aqueous phosphoric acid, and further regenerate fractions are then collected the volumes of which differ by no more than 50% from the volumes of the portions of aqueous phosphoric acid added to the ion exchanger to produce the regenerate fractions in question, after adding the final portion of aqueous phosphoric acid at least enough water is used for rewashing to displace the final portion of aqueous phosphoric acid from the ion exchanger and collect it as the final regenerate fraction, either enough phosphoric acid with a concentration in the range 60 to 95 wt. % is added to the ion exchanger to balance out the phosphoric acid depletion of the first regenerate fraction in relation to the first portion of aqueous phosphoric acid added and then the regenerate fractions obtained from the previous cycle are added in the order obtained, as portions of aqueous phosphoric acid for the next regeneration cycle, or such a quantity of concentrated phosphoric acid is added to the first regenerate fraction collected after flushing out the concentrate fraction that both the concentration of phosphoric acid, and the volume, of this regenerate fraction substantially correspond to the phosphoric acid concentration and the volume of the original first portion of aqueous phosphoric acid before addition to the ion exchanger, and for a corresponding subsequent regeneration cycle of a weakly acid ion exchanger charged with suitable metal ions, the individual regenerate fractions from the previous regeneration cycle are added to the ion exchanger in the order obtained as individual portions of aqueous phosphoric acid.

The invention relates to a special process for the fractionated regeneration of a weakly acid ion exchanger charged with divalent metal ions selected from zinc, nickel and manganese ions. A valuable product solution enriched with these divalent metal ions is obtained from this, which can be processed or recycled at low cost. The process can, for example, be used in the field of phosphating of metal surfaces, for example vehicle bodywork, with a zinc phosphating solution. As a result of the process according to the invention, a phosphoric-acid metal phosphate solution is obtained, which preferably contains no further anions, except optionally nitrate ions.

The processing of nickel-containing rinsing solutions from the zinc phosphating process with a weakly acid ion exchanger is known from German Patent Application DE-A-199 18 713. German Patent Application DE-A-______ filed at the same time as the present patent application refines the process in that the weakly acid ion exchanger is used substantially in its acid form. As weakly acid ion exchangers can be used, for example, such chelating imino diacetic acid groups as are available commercially under various names: A suitable product is Lewatit® TP 207 or TP 208 from Bayer. Other suitable ion exchangers are IRC 718/748 from Rohm & Haas and S-930 from Purolite.

The regeneration of cation-charged ion exchangers with acids in individual fractions is known. According to the embodiments of DE-A-199 18 713, 3 fractions, for example, each of 40% phosphoric acid, can be used. The phosphoric-acid solution containing zinc and nickel obtained according to these examples can be re-used to augment a phosphating bath.

The fractionated regeneration with acid of a cation exchanger charged with chromium and zinc ions is known from Chemical Abstracts Section 68:107169. In this case, the first fraction, which shows the highest content of metal ions, is discarded. The other acid fractions, which show lower contents of metal ions are then re-used for further regeneration cycles. Japanese Patent Application JP 52030261 A2 (quoted according to Chemical Abstracts 87:43816) describes the fractionated regeneration of a zinc-charged strongly acid cation exchanger with hydrochloric acid.

The object to be achieved by the present invention is to provide an improved process for the regeneration of a weakly acid ion exchanger charged with divalent metal ions selected from nickel, zinc and manganese ions. A phosphoric-acid metal phosphate solution should be obtained from this process, which can either be processed at low cost or re-used for the phosphating of metal surfaces with zinc phosphating solutions. The means of obtaining such a charged weakly acid ion exchanger by processing waste water from the phosphating process is described in DE-A-199 18 713 and in German Patent Application DE-A-______ filed at the same time.

The present invention relates therefore to a process for the fractionated regeneration of a weakly acid ion exchanger charged with divalent metal ions selected from nickel, zinc and manganese ions, obtaining a metal-containing phosphoric-acid valuable product solution. In this process, the procedure for charging the ion exchanger allows control over which of the above-mentioned metal ions or mixtures thereof are preferably bonded to the ion exchanger.

If the ion exchanger is used in the form in which it is fully neutralised with alkali metal ions, preferably sodium ions (normally called the di-Na form), nickel and zinc and manganese ions are bonded. Accordingly, when regenerating this ion exchanger, a metal-containing valuable product solution can be obtained, which contains all three metal ions.

However if, when charging, the ion exchanger is used in a form in which it is only semi-neutralised (called the mono-Na form), nickel and zinc ions are bonded selectively as opposed to manganese ions. The ion exchanger then substantially contains these two metal ions, so that a valuable product solution containing nickel and zinc is obtained from regeneration.

This procedure for the treatment of rinsing water from the phosphating process is described in more detail in German Patent Application DE-A- 199 18 713. If, when charging, the ion exchanger is used in virtually un-neutralised form (called the H-form), it binds nickel ions selectively as opposed to zinc and manganese ions. This procedure is the subject matter of German Patent Application DE-A-______ filed at the same time. According to this, when regenerating an ion exchanger charged in this way, a metal-containing valuable product solution is obtained, which contains primarily nickel ions.

The charged ion exchanger is regenerated in that at least 2 portions of aqueous phosphoric acid are added to it one after the other, whereby each successive portion of aqueous phosphoric acid has a lower concentration of phosphoric acid than the previous portion. This makes it possible to minimise the quantity of fresh water required to wash out the acid from the ion exchanger after the final regeneration stage.

After adding the first portion of aqueous phosphoric acid to the ion exchanger the water displaced by the phosphoric acid in the ion exchange column is either discarded or re-used and a concentrate fraction is then flushed out which contains at least 0.5 wt. % of the above-mentioned metal ions. The volume of this concentrate fraction should substantially be no greater than twice the volume of the first portion of aqueous phosphoric acid added. A lower volume may be selected if as high as possible a concentration of metal ions is desired.

After the addition of each of the next portions of aqueous phosphoric acid to the ion exchanger, further regenerate fractions are collected, the volumes of each of which differ by no more than 50% from the volumes of the portions of aqueous phosphoric acid added to the ion exchanger to produce each regenerate fraction. The volumes of the regenerate fractions differ preferably as little as possible, in particular not at all, from the volumes of the portions of aqueous phosphoric acid added in each case. The final result of this is that as many regenerate fractions are obtained as portions of aqueous phosphoric acid added to the ion exchanger.

As the regenerate fractions are used in a further regeneration cycle of the ion exchanger as ‘portions of aqueous phosphoric acid’ added for regeneration, the result of this volume condition is that the number of regenerate fractions obtained over any number of regeneration cycles corresponds in each case to the number of ‘portions of aqueous phosphoric acid’ added for regeneration.

After the final portion of aqueous phosphoric acid has been added in each regeneration cycle, rinsing is carried out with at least enough water to displace the final portion of aqueous phosphoric acid previously added from the ion exchanger and collect it as the final regenerate fraction. The phosphoric acid in the first regenerate fraction collected after flushing out the concentrate fraction is depleted in comparison with the first portion of aqueous phosphoric acid added.

There are various procedures for re-setting the same conditions for each regeneration cycle. One option is, using the dead volume of the ion exchanger, to add to it sufficient phosphoric acid with a concentration in the range 60 to 95 wt. %, to balance out the phosphoric acid depletion from the first regenerate fraction in relation to the first portion of aqueous phosphoric acid added.

At the beginning of the next regeneration cycle the individual regenerate fractions obtained from the previous cycle are then added in the order in which they were obtained as the portion of aqueous phosphoric acid. An alternative to this is to add to the first regenerate fraction collected after flushing out the concentrate fraction such a quantity of concentrated phosphoric acid that both the concentration of the phosphoric acid in this regenerate fraction and the volume of this regenerate fraction substantially correspond to the phosphoric acid concentration and volume of the original first portion of aqueous phosphoric acid before it was added to the ion exchanger. This can be controlled through the concentration and quantity of the phosphoric acid used. 85% phosphoric acid, for example, can be used for this.

For a subsequent regeneration cycle of a weakly acid ion exchanger charged with the above-mentioned metal ions, the individual regenerate fractions from the previous regeneration cycle are added to the ion exchanger in the order in which they were obtained as individual portions of aqueous phosphoric acid and the concentrate fraction and the regenerate fraction to be used for the next regeneration step are collected as described above.

Thus in each regeneration cycle one concentrate fraction is flushed out, which shows a content of at least 0.5 wt. % of metal ions. A number of regenerate fractions are then collected, which correspond to the number of portions of aqueous phosphoric acid added. The first regenerate fraction is augmented with phosphoric acid according to one of the above-mentioned processes to obtain once again a first portion of aqueous phosphoric acid, the concentration and volume of which correspond to those previously added to the ion exchanger. The final regenerate fraction is obtained by displacing the acid remaining in the ion exchanger bed with water.

The times at which collection of the concentrate fraction and the individual regenerate fractions begins can be set according to volume and/or established as a result of determining metals or phosphates. In the presence of color-bearing metal ions, the times can also be determined by the color of the column run-off.

The volume of the first portion of aqueous phosphoric acid preferably corresponds substantially to the bed volume of the ion exchanger. ‘Bed volume’ hereinafter abbreviated to BV, is deemed to be the total volume of ion exchanger particles and the water phase between these particles. If an ion exchanger column is used as is customary, the bed volume is the product of the level of the ion exchanger in the column and the diameter of the column. In this case ‘substantially’ is deemed to mean that the volume of the first portion of aqueous phosphoric acid differs from the bed volume of the ion exchanger by no more than 25%, preferably no more than 15% and in particular no more than 5%.

The volumes of the other portions of aqueous phosphoric acid are selected preferably so as to be substantially equal to each other and 10% to 50%, preferably 20% to 30%, lower than the volume of the first portion of aqueous phosphoric acid. The other portions of aqueous phosphoric acid preferably each have a volume that is 10 to 50%, preferably 20 to 30%, for example 25% lower than is the bed volume of the ion exchanger. Thus if, for example, the ion exchanger has a bed volume of 4 l, the first portion of aqueous phosphoric acid used is preferably also 4 l and the other portions of aqueous phosphoric acid used are preferably 3 l.

Besides the term ‘bed volume’ the term ‘dead volume’ is also used in this patent application. This refers to the volume of the liquid phase in and between the particles of the ion exchanger resin and any additional volumes over and above the exchanger charge, which can be filled with liquid.

The first portion of aqueous phosphoric acid preferably shows a phosphoric acid concentration in the range 20 to 60 wt. % and in particular in the range 30 to 50 wt. %, for example 40 wt. %. The final portion of aqueous phosphoric acid preferably has a phosphoric acid concentration in the range 1 to 10 wt. %, in particular in the range 2 to 6 wt. %, for example 4 about wt. %.

The portions of aqueous phosphoric acid used per regeneration cycle are preferably 3 to 10, in particular 5 to 8. When using 5 portions of aqueous phosphoric acid these can for example show approximately the following concentrations of phosphoric acid: 40 wt. %, 15 wt. %, 12 wt. %, 9 wt. % and 4 wt. %.

Each portion of aqueous phosphoric acid may contain in all up to 10 mol % nitric acid, hydrochloric acid and/or hydrofluoric acid in relation to the total quantity of acids. It is therefore preferable that the aqueous phosphoric acid for the regeneration of the ion exchanger contains no more than 0.1 mol % in relation to the total quantity of acids, of acids other than these.

The concentrate fraction flushed out in each regeneration cycle, which is a metal-containing valuable product solution, preferably has a metal content of over 0.8 wt. % and in particular over 1 wt. %. The metal contents obtainable in practice are generally no higher than 5 wt. %, in particular no higher than 3.5 wt. %. These concentration ranges are perfectly adequate for the preferred use for regeneration of a zinc phosphating solution.

Thus the valuable product solution containing metals (concentrate fraction) is preferably re-used as such i.e. as obtained from regeneration of the ion exchanger, or in particular after augmenting with agents for the augmenting of a phosphating solution. Depending on the process, zinc and manganese compounds in particular and optionally so-called ‘phosphating accelerators’ may be considered as agents for augmenting the metal-containing valuable product solution.

In a particularly preferred embodiment, the process according to the invention is carried out in such a way that nickel ions are bonded more strongly to the weakly acid ion exchanger than zinc and manganese ions. As already explained above, this can be achieved by using the ion exchanger in its H-form for charging. This process is described in more detail in German Patent Application DE-A-______ filed at the same time.

The subject matter of this parallel application is a process for the processing of a nickel-containing aqueous solution, consisting of phosphating bath overflow and/or rinsing water from the phosphating process, phosphating being carried out with an acid aqueous phosphating solution, which contains 3 to 50 g/l phosphate ions, calcuated as PO43-, 0.2 to 3 g/l zinc ions, 0.01 to 2.5 g/l nickel ions, optionally other metal ions and optionally accelerators, the phosphating bath overflow and/or rinsing water from the phosphating process being passed over a weakly acid ion exchanger, characterised in that the acid groups of the ion exchanger are neutralised with alkali metal ions to no more than 15% and that the nickel-containing aqueous solution shows a pH value in the range 2.5 to 6, preferably 3 to 4.1 when added to the ion exchanger.

Thus, accordingly, a weakly acid ion exchanger should be used the acid groups of which are neutralised with alkali metal ions to no more than 15%. However the aim should be that the acid groups of the ion exchanger are neutralised with alkali metal ions to no more than 5%, preferably no more than 3% and in particular no more than 1%. Ideally, the ion exchanger contains no alkali metal ions at all. As equilibrium processes play a part in the regeneration of a charged ion exchanger, this desired ideal state of the ion exchanger cannot, however, always be achieved.

A simple criterion for determining whether or not the acid groups are neutralised little enough by the alkali metal ions, is the bed volume of the ion exchanger. The bed volume of weakly acid ion exchangers usually depends on the degree of neutralisation of the acid groups. If, for example, the disodium form of a weakly acid ion exchanger with imino diacetic acid groups, for example Lewatit® TP 207, with a bed volume of 500 ml is washed with acid to such an extent that the sodium ions are removed as far as possible, the bed volume shrinks to 400 ml. The bed volume of the mono-sodium form is 450 ml. Such an ion exchanger is in a state to be used according to the invention if the bed volume of the ion exchanger which, in the disodium form, is 500 ml, is no higher than 415 ml.

If the charging of the weakly acid ion exchanger is carried out as described above, nickel ions in particular are bonded finally, i.e. until break-through of the nickel. Accordingly the metal-containing valuable product solution obtained by the regeneration process according to the invention is preferably a nickel-containing valuable product solution. To return the ion exchanger to its H-form after regeneration, so that it is particularly suitable for the binding of nickel ions, the following method should be followed:

As described above, the final portion of aqueous phosphoric acid in each regeneration cycle is displaced from the ion exchanger bed with water. To prepare the ion exchanger to be used again to bind nickel ions from waste water containing nickel, for example the rinsing water from the phosphating process, it is rinsed with more water or with a quantity of lye which corresponds to a maximum of 0.5 bed volumes of 4% sodium hydroxide, until the pH value of the rinsing solution running off from the ion exchanger is between 2.1 and 4.5 and in particular between 3.0 and 4.1. Under these conditions the ion exchanger is returned to the H-form, i.e. no more than 15% of the acid groups of the ion exchanger are neutralised with sodium ions.

For the process described above a weakly acid ion exchanger is preferably used which carries chelate-forming imino diacetic acid groups.

For the following embodiment, an ion exchanger with imino diacetic acid groups (Lewatit® TP 207) is used, which has been pre-charged in its H-form with a rinsing solution of pH 4. Charging was carried out with 648 bed volumes phosphoric-acid rinsing solution, which contains 25 ppm Ni, 25 ppm Mn and 50 ppm Zn. Regeneration was carried out in the rising stream, but can be carried out in the falling stream. The exchanger in an ion exchange column had a bed volume of 400 ml at a dead volume of 400 ml. For the first regeneration cycle, heavy-metal-free phosphoric acid was used in a quantity and concentration as in portions P(n).1 to P(n).5 listed in the following table. After flushing out a nickel-containing concentrate K(n) for processing or re-use, for example to augment a zinc phosphating solution, 5 further fractions containing only nickel were collected and, after augmenting the first fraction with phosphoric acid, were used for the next regeneration cycle. Regeneration was then continued, flushing out a nickel-containing concentrate and re-using the regenerate fraction as a new portion of aqueous phosphoric acid for the next regeneration cycle. The ion exchanger was of course re-charged with nickel ions between 2 regeneration cycles. This is described in more detail below.

During repeated regeneration and charging cycles the following process is used for regeneration: Portions of aqueous phosphoric acid of the composition hereinafter called P(n).1 to P(n).5 were used for the n-th regeneration step. As run-off from the ion exchanger, substantially nickel-free column water corresponding to the dead volume of the exchanger was first drained off. A concentration fraction with 1.8 wt. % nickel was then flushed out, which can be used to augment a phosphating bath. Finally the regenerate fractions F(n).1 to F(n).5 are obtained, which are added to the ion exchanger in a subsequent regeneration cycle. Here the fraction F(n).1 from the n-th cycle is augmented with phosphoric acid to produce the portion P(n+1).1 for the (n+1)-th cycle. The rest of the method is shown in the following illustration, which reproduces conditions in equilibrium.

Regeneration cycle n:

StepAddition to ion exchangerRun-off from ion exchanger1.0-400 ml column water, 0% Ni1.1P(n).1: 400 ml 40% H3PO4, 0.375% NiK(n): 400 ml concentrate: 10-15% H3PO4, 1.8% Ni1.2P(n).2: 300 ml 15% H3PO4, 0.4% NiF(n).1: 300 ml 20-24% H3PO4, 0.5% Ni1.3P(n).3: 300 ml 12% H3PO4, 0.3% NiF(n).2: 300 ml 15% H3PO4, 0.4% Ni1.4P(n).4: 300 ml 9% H3PO4, 0.15% NiF(n).3: 300 ml 12% H3PO4, 0.3% Ni1.5P(n).5: 300 ml 4% H3PO4, 0.05% NiF(n).4: 300 ml 9% H3PO4, 0.15% Ni1.6700 ml fully desalinated waterF(n).5: 300 ml 4% H3PO4, 0.05% Ni

Regeneration cycle (n+1)

To F(n).1 (300 ml) from cycle n is added 100 ml 85% H3PO4, so as to produce 400 ml P(n+1).1 for the (n+1)th cycle.

F(n).2 from the n-th cycle is used as P(n+1).2 in the (n+1)th cycle

F(n).3 from the n-th cycle is used as P(n+1).3 in the (n+1)th cycle

F(n).4 from the n-th cycle is used as P(n−1).4 in the (n+1)th cycle

F(n).5 from the n-th cycle is used as P(n+1).5 in the (n+1)th cycle.

StepAddition to ion exchangerRun-off from ion exchanger2.0-400 ml column water, 0% Ni2.1P(n+1).1: 400 ml 40% H3PO4, 0.375% NiK(n+1).1: 400 ml concentrate: 10-15% H3PO4, 1.8% Ni2.2P(n+1).2: 300 ml 15% H3PO4, 0.4% NiF(n+1).1: 300 ml 20-24% H3PO4, 0.5% Ni2.3P(n+1).3: 300 ml 12% H3PO4, 0.3% NiF(n+1).2: 300 ml 15% H3PO4, 0.4% Ni2.4P(n+1).4: 300 ml 9% H3PO4, 0.15% NiF(n+1).3: 300 ml 12% H3PO4, 0.3% Ni2.5P(n+1).5: 300 ml 4% H3PO4, 0.05% NiF(n+1).4: 300 ml 9% H3PO4, 0.15% Ni2.6700 ml fully desalinated waterF(n+1).5: 300 ml 4% H3PO4, 0.05% Ni

Continuing accordingly for further regeneration cycles.

1. Process for the fractionated regeneration of a weakly acid ion exchanger charged with divalent metal ions selected from nickel, zinc and manganese ions, obtaining a phosphoric-acid valuable product solution which contains these metal ions, wherein at least two portions of aqueous phosphoric acid are added to the ion exchanger one after the other, wherein each successive portion of aqueous phosphoric acid shows a lower phosphoric acid concentration than the previous one, wherein after adding the first portion of aqueous phosphoric acid to the ion exchanger, a concentrate fraction in the form of a phosphoric-acid valuable product solution containing metal ions is flushed out which contains at least 0.5 wt. % metal ions and of which the volume is no greater than twice the volume of the first portion of aqueous phosphoric acid, and further regenerate fractions are then collected the volumes of which differ by no more than 50% from the volumes of the portions of aqueous phosphoric acid added to the ion exchanger to produce the regenerate fractions in question, after adding the final portion of aqueous phosphoric acid at least enough water is used for rewashing to displace the final portion of aqueous phosphoric acid from the ion exchanger and collect it as the final regenerate fraction, either enough phosphoric acid with a concentration in the range 60 to 95 wt. % is added to the ion exchanger to balance out the phosphoric acid depletion of the first regenerate fraction in relation to the first portion of aqueous phosphoric acid added and then the regenerate fractions obtained from the previous cycle are added in the order obtained, as portions of aqueous phosphoric acid for the next regeneration cycle, or such a quantity of concentrated phosphoric acid is added to the first regenerate fraction collected after flushing out the concentrate fraction that both the concentration of phosphoric acid, and the volume, of this regenerate fraction substantially correspond to the phosphoric acid concentration and the volume of the original first portion of aqueous phosphoric acid before addition to the ion exchanger, and for a corresponding subsequent regeneration cycle of a weakly acid ion exchanger charged with suitable metal ions, the individual regenerate fractions from the previous regeneration cycle are added to the ion exchanger in the order obtained as individual portions of aqueous phosphoric acid.

2. Process according to claim 1, characterised in that the first portion of aqueous phosphoric acid shows a volume that substantially corresponds to the bed volume of the ion exchanger, and that the volumes of the other portions of aqueous phosphoric acid are substantially equal to each other and 10 to 50 percent, preferably 20 to 30 percent lower than the volume of the first portion of aqueous phosphoric acid.

3. Process according to one or both of claims 1 and 2, characterised in that the first portion of aqueous phosphoric acid has a phosphoric acid concentration in the range 20 to 60 wt. %, preferably in the range 30 to 50 wt. %.

4. Process according to one or more of claims 1 to 3, characterised in that the final portion of aqueous phosphoric acid shows a phosphoric acid concentration in the range 1 to 10 wt. %, preferably in the range 2 to 6 wt. %.

5. Process according to one or more of claims 1 to 4, characterised in that 3 to 10, preferably 5 to 8 portions of aqueous phosphoric acid are used.

6. Process according to one or more of claims 1 to 5, characterised in that the aqueous phosphoric acid contains in all up to 10 mol % in relation to the total quantity of acids, of nitric acid, hydrochloric acid and/or hydrofluoric acid and no more than 0.1 mol % in relation to the total quantity of acids, of acids other than these.

7. Process according to one or more of claims 1 to 6, characterised in that the phosphoric-acid valuable product solution containing metals has a metal content of over 0.8 wt. %, preferably of over 1 wt.-% but no higher than 5 wt. %, preferably no higher than 3.5 wt. %.

8. Process according to one or more of claims 1 to 7, characterised in that the metal-containing valuable product solution is used as such or after augmenting with agents for the augmenting of a phosphating solution.

9. Process according to one or more of claims 1 to 8, characterised in that, after displacement of the final portion of aqueous phosphoric acid with water, the ion exchanger is rinsed with more water or with a quantity of lye, which corresponds to a maximum of 0.5 bed volumes of 4% sodium hydroxide, until the pH value of the rinsing solution running off from the ion exchanger is between 2.1 and 4.5.

10. Process according to one or more of claims 1 to 10, characterised in that the weakly acid ion exchanger carries chelate-forming imino diacetic acid groups.
